(19) United States
(12) Patent Application Publication
(10) Pub. No.: US 2009/0235958 A1
(43) Pub. Date: Sep. 24, 2009

(54) DEGREASING SYSTEM

(75) Inventors: Rick Kamino, Palm Desert, CA (US); Jerry J. Castleton, Laguna Beach, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ZTEC International, Costa Mesa, CA (US)

(21) Appl. No.: 12/389,582

(22) Filed: Feb. 20, 2009

Related U.S. Application Data
(60) Provisional application No. 61/070,550, filed on Mar. 24, 2008.

(51) Int. Cl. B08B 3/04

(52) U.S. Cl. 134/25.5; 134/85

(57) ABSTRACT

A cleaning system used for cleaning small parts, and more specifically for degreasing small parts, is provided that comprises a top work station, a bottom work station, and a grid tray having a grid portion. The top and bottom work stations can be assembled into a container and may employ one or more clips to secure the assembly. A method of cleaning items using the cleaning system is also provided. Further provided is a kit comprising the cleaning system, one or more brushes, and one or more pairs of gloves.

### CROSS-REFERENCE TO RELATED APPLICATIONS

This application claims the benefit of the filing date of U.S. Provisional Patent Application No. 61/070,550 filed Mar. 24, 2008, entitled DEGREASING SYSTEM, the disclosure of which is hereby incorporated herein by reference.

### BACKGROUND OF THE INVENTION

The present invention relates to apparatus and methods for cleaning, and more particularly, to apparatus and methods for degreasing small parts.

Cleaning small items often requires individual attention and care. One who works with engines, for instance, utilizes many small parts and tools that must be cleaned to remove dirt, grease, etc. Cleaning these items can often be time consuming depending on the number and intricacy of the items to be cleaned. Depending on the nature and use of such items, they may need to be soaked in a cleaning solution for a period of time to aide in the removal of buildup. Further, some items require different or unique cleaning solutions or solvents based on their use.

Using a sink for cleaning small parts can be problematic for many different reasons. The basin of a sink is usually much larger than necessary for cleaning small items. Often, more of a particular solvent or cleaning agent is poured into the sink than is needed, resulting in waste when the liquid is drained in order to rinse the cleaned items. The sink may be plugged to prevent such waste, though this temporarily prevents it from being used for other purposes. Using a plugged sink also requires sifting through the cleaning agent to collect the cleaned items or to pull the plug. As the solvent/agent can be dark in color or include suds or other dirt or grease, this can be time consuming and may also pose a threat to the individual such as exposure to harsh chemicals or accidental contact with dangerous edges or portions of the items. There is also a chance that an item might be overlooked and be lost through the drain.

Therefore, there exists a need for an apparatus and method for safely and efficiently cleaning small items.

### SUMMARY OF THE INVENTION

A first aspect of the present invention is a cleaning system for cleaning items at least partially submerged within a liquid comprising a bottom work station, a top work station, and a grid tray. In accordance with one embodiment of this first aspect, the bottom work station may include a bottom outer surface and a bottom inner surface, and may be configured to contain a liquid. The top work station may include a top outer surface and a top inner surface. The top work station may have a nesting position so as to be nestingly received within the bottom work station wherein the top outer surface faces the bottom inner surface. The top work station may also have a covering position wherein the top inner surface faces the bottom inner surface. The grid tray may include a grid portion, and may be configured to be inserted into the bottom work station and to contain items to be at least partially submerged and cleaned in a liquid. The grid tray may be configured to be received and retained on the top outer surface when the top work station is in the covering position to allow for drying of the items while the grid tray is positioned on the top work station.

In accordance with other embodiments of the first aspect, the liquid may be a cleaning solution or a degreasing solution. When in the covering position, the top work station and the bottom work station may interconnect to form a closed container. The grid tray may be configured to be inserted into the top work station. The cleaning system may further include at least one clip configured to secure the top work station to the bottom work station. The at least one clip may be attached to the top work station and/or the bottom work station. The top work station may include a top plane and a lip disposed on the top outer surface and circumferentially about the top plane. The top plane and the grid portion may be substantially similarly dimensioned, and the lip may removably secure the grid tray to the top work station. The top work station may include a top rim and a gasket disposed at least partially within the top rim. Similarly, the bottom work station may include a bottom rim and a gasket disposed at least partially within the bottom rim. The grid portion may be perforated. The top work station may include a plurality of walls that define an opening. The cleaning system may further include at least one of a cleaning brush and a pair of gloves. The at least one cleaning brush and pair of gloves may be disposed within the top work station when the top work station is in the nesting position.

A second aspect of the present invention is a method of cleaning items including a cleaning system, as described above. In accordance with one embodiment of this second aspect, the method may include providing a cleaning system, placing the grid tray into the bottom work station, placing items to be cleaned into the grid tray, pouring the liquid into the bottom work station so as to at least partially submerge the items, removing the grid tray containing the items from the bottom work station, placing the top work station in the covering position and onto the bottom work station, and placing the grid tray containing the items onto the top outer surface. In accordance with other embodiments of the second aspect, the liquid may be a cleaning solution or a degreasing solution.

A third aspect of the present invention is a cleaning system for cleaning items at least partially submerged within a liquid comprising a bottom work station, a top work station, and a grid tray. In accordance with one embodiment of this third aspect, the bottom work station may have a tray-like configuration with a bottom outer surface and a bottom inner surface. The bottom work station may further include a bottom plane and four bottom walls extending therefrom, with each bottom wall being connected to exactly two other bottom walls. Each bottom wall may form an obtuse angle with the bottom plane. The bottom work station may be configured to contain the liquid. The top work station may have a tray-like configuration with a top outer surface and a top inner surface. The top work station may further include a top plane and four top walls extending therefrom, with each top wall being connected to exactly two other top walls. Each top wall may form an obtuse angle with the top plane. The top work station may be configured to be arranged in a nesting position wherein the top outer surface faces the bottom inner surface, and in a covering position wherein the top inner surface faces the bottom inner surface. The grid tray may have a grid portion, and may be configured to be inserted into the bottom work station and to contain items to be at least partially submerged and cleaned in the liquid. The grid tray may have a tray-like configuration with a grid tray outer surface and a grid tray inner surface. The grid tray may further include four grid tray walls extending from the grid portion, with each grid tray wall being connected to exactly two other grid tray walls. Each grid tray wall may form an obtuse angle with the grid portion. The grid tray may be further configured to be received and retained on the top outer surface when the top work station is in the covering position while the grid tray contains the items to allow for drying of the items while the grid tray is positioned on the top work station. The system may be configured to be arranged in a storage position wherein the top work station is disposed in the nesting position in the bottom work station, and the grid tray disposed therebetween. The system may also be configured to be arranged in a cleaning position wherein the top work station is disposed in the covering position on the bottom work station, and the grid tray is disposed within the bottom work station. The system may additionally be configured to be arranged in a drying position wherein the top work station is disposed in the covering position on the bottom work station, and the grid tray is retainingly disposed on the top outer surface of the top work station. In accordance with other embodiments of the third aspect, the liquid may be a cleaning solution or a degreasing solution.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a front perspective view of an embodiment of a cleaning system according to the present invention.

FIG. 2 is a front view of the cleaning system shown in FIG. 1.

FIG. 3 depicts a step in a method of using the cleaning system shown in FIG. 1.

FIG. 4 depicts another step in a method of using the cleaning system shown in FIG. 1.

FIG. 5 depicts another step in a method of using the cleaning system shown in FIG. 1.

FIG. 6 depicts another step in a method of using the cleaning system shown in FIG. 1.

FIG. 7 is an exploded view of another embodiment of a cleaning system according to the present invention.

FIG. 8 is a front perspective view of the cleaning system shown in FIG. 7.

FIG. 9 is a front perspective view of a clip of the cleaning system shown in FIG. 7.

FIG. 10 is a plan view of a grid tray of the cleaning system shown in FIG. 7.

### DETAILED DESCRIPTION

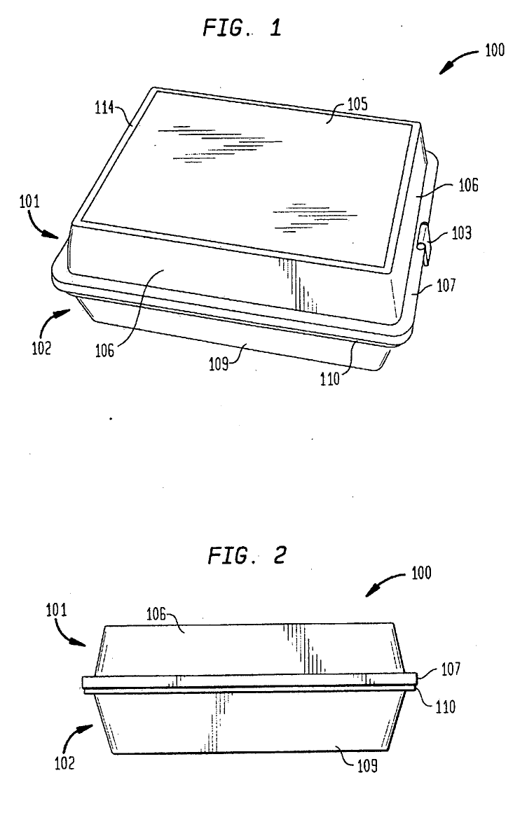

System 100 is depicted in FIGS. 1-6 having a top work station 101, a bottom work station 102, a grid tray 104, and at least one clip 103. Top work station 101 includes a top plane 105, top walls 106, a top rim 107, a top outer surface 117, and a top inner surface 118. Top work station 101 preferably has four top walls 106 that are each connected to two adjacent top walls 106. Each top wall 106 preferably forms an obtuse angle with top plane 105. Bottom work station 102 similarly includes a bottom plane 108 (not shown), bottom walls 109, a bottom rim 110, a bottom outer surface 119, and a bottom inner surface 120. Bottom work station 102 preferably has four bottom walls 109 that are each connected to two adjacent top walls 109. Each bottom wall 109 preferably forms an obtuse angle with bottom plane 108. Top work station 101 and bottom work station 102 are each tray-like in nature and are similarly sized and shaped such that when they are connected, system 100 is a substantially hollow and closed container. Top work station 101 and bottom work station 102 can be further secured together with at least one clip 103. Clip 103 is preferably disposed on or attached to top rim 107, but may also be provided separately. Clip 103 may also or alternatively be disposed on or attached to bottom rim 110.

Top work station 101 has a nesting position and a covering position with respect to bottom work station 102. In the nesting position, top work station 101 is nestingly received within bottom work station 102 such that top outer surface 117 faces bottom inner surface 120. In the covering position, top work station 101 is positioned as shown in FIG. 1, such that top inner surface 118 faces bottom inner surface 120.

Grid tray 104 has a grid portion 111, grid tray walls 112 a grid tray rim 113, a grid tray inner surface 121, and a grid tray outer surface 122. Grid tray 104 preferably has four grid tray walls 112 that are each connected to two adjacent grid tray walls 112. Each grid tray wall 112 preferably forms an obtuse angle with grid portion 111. Grid portion 111 is substantially completely perforated to include at least one aperture therein, similar in nature to a screen. Grid tray 104 is also preferably tray-like in shape such that it may fit substantially within either or both top work station 101 or bottom work station 102. When grid tray 104 is positioned, for example, in bottom work station 102, grid portion 111 rests near bottom plane 108. In such a configuration, items placed in grid tray 104 may be at least partially submerged in a liquid used to fill bottom work station 102. Further, top rim 107 and bottom rim 110 are designed to enclose grid tray rim 113 when connected such that grid tray 104 is substantially prevented from moving relative to either work station.

The tray-like nature of top work station 101, bottom work station 102, and grid tray 104 allow the three components to be stacked together, one inside the next, in any order. Such a configuration reduces the overall size and shape of system 100 for storage and/or packaging. System 100 may be configured to be arranged in a storage position wherein top work station 101 is disposed in the nesting position in bottom work tray 102, and grid tray 104 is disposed between top work station 101 and bottom work station 102. An alternative storage position may include grid tray 104 disposed within top work station 101, which is in the nesting position. System 100 may also be configured to be arranged in a cleaning position wherein top work station 101 is disposed in the covering position on bottom work station 102, and grid tray 104 is disposed within bottom work station 102 such that grid tray outer surface 122 faces bottom inner surface 120. An alternative cleaning position may be similarly configured, although without top work station 101. Further, system 100 may be configured to be arranged in a drying position wherein top work station 101 is disposed in the covering position on bottom work station 102, and grid tray 104 is retainingly disposed on top work station 101, such that grid tray outer surface 122 faces top outer surface 117.

The liquid used with system 100 and in related cleaning methods according to the present invention can be any type of cleaning solution, agent, or solvent. Preferably, the liquid is a degreasing solution. Of course, the cleaning solution may be plain water.

Top plane 105 of top work station 101 is substantially similarly dimensioned with respect to grid portion 111. Top work station 101 further includes a lip 114 disposed circumferentially about top plane 105. That is, lip 114 extends upward from top walls 106 to a position above top plane 105, thereby essentially creating a shallow recess on the outer portion of top work station 101. When top work station is in the covering position, grid tray 104 may be placed on top of top work station 101, as shown in FIG. 6. In this configuration, system 100 allows for drying and/or removal of the cleaned items. Lip 114 acts to prevent liquid from leaking or pouring from top plane 105 over top walls 106. Further, as top plane 105 includes dimensions similar to those of grid portion 111, lip 114 helps to removably secure and maintain grid tray 104 atop top work station 101 during a cleaning process.

A gasket (not shown) may be disposed at least partially within top rim 107 and/or bottom rim 110 to substantially seal top work station 101 with bottom work station 102 such that system 100 is substantially leak-proof. Such may also prevent the release of potentially harmful odors produced from a cleaning process or solution when system 100 is closed. It may also be desirable to seal system 100 while items soak in a liquid so that accidental bumping of system 100 does not result in spillage.

It is further contemplated that top work station 101 and bottom work station 102 be so similarly sized and shaped that the roles of each may be reversed during a cleaning process.

It may be beneficial that any items placed in grid tray 104 be small enough to be completely submerged in the liquid disposed in bottom work station 102. This would allow the items to be fully soaked in advance of manual cleaning. Along these lines, the size and shape of system 100 can be designed with regard to the items with which it is designed and intended to be used. Of course, system 100 may still be used with larger items, though they may be reoriented or rotated during the cleaning process for more effective cleaning.

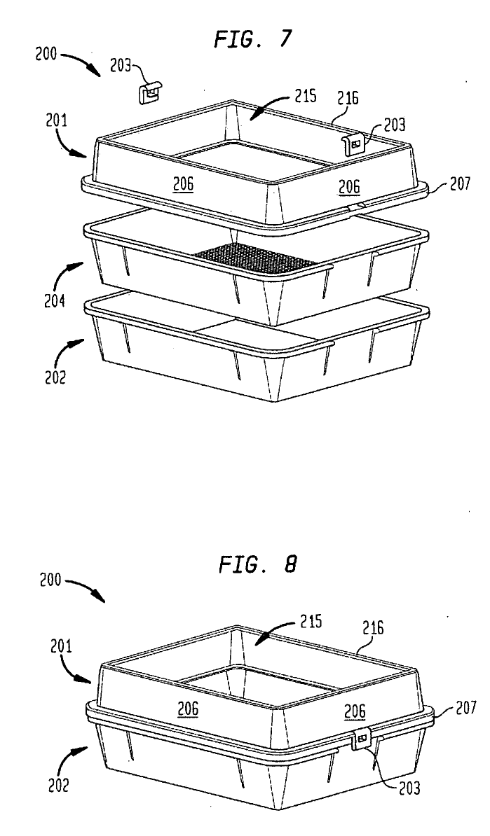

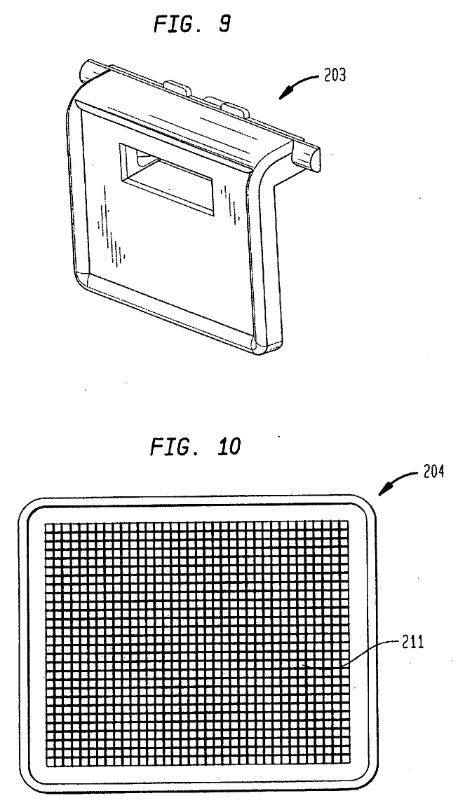

Another embodiment of the present invention is depicted in FIGS. 7-10. System 200 includes a top work station 201, bottom work station 202, grid tray 204, and two clips 203, each of which is similar in nature to the like-components of system 100. Top work station 201, however, includes top walls 206, a top rim 207, and an opening 215, which is essentially defined by top walls 206 and replaces top plane 105 of system 100. Top walls 206 together form an upper edge 216, upon which grid tray 204 may rest in a configuration similar to that depicted in FIG. 6. When grid tray 204 is placed on top work station 201, liquid is free to drain directly through opening 215 and into bottom work station 202.

All elements according to a system of the present invention may be comprised of any type of durable plastic, metal, or other similar material. As a preferred system is comprised of plastic, each component is preferably constructed through a molding process. An important characteristic of the one or more materials that comprise a system of the present invention is their ability to withstand a reaction with any potential liquid that is to be used for cleaning. The material should also be easily adaptable for screen printing or other types of product identification.

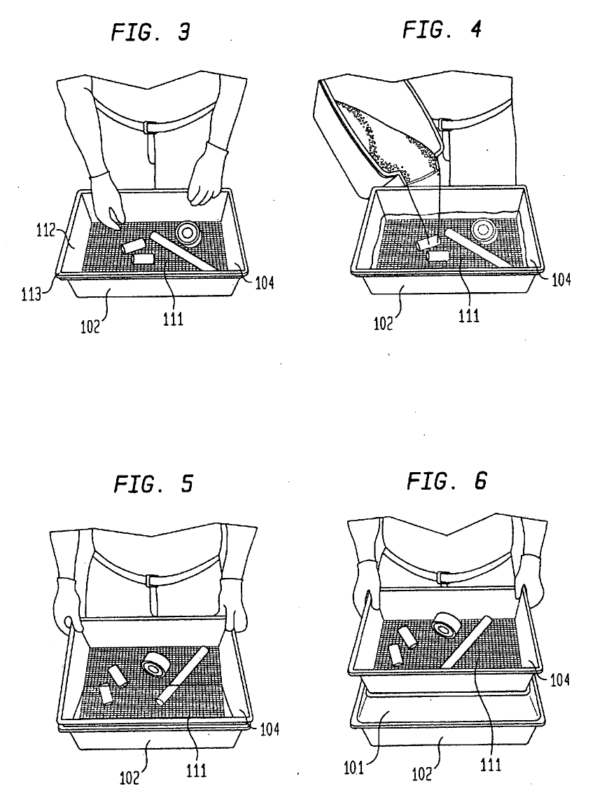

FIGS. 3-6 depict a method of cleaning items using system 100. As shown in FIG. 3, grid tray 104 is first positioned within bottom work station 102, which may be set on a counter or other flat surface. One or more items which require cleaning are then placed within grid tray 104. A liquid, such as a cleaning agent, is then added to bottom work station 102 as shown in FIG. 4. Of course, the liquid could be poured into bottom work station 102 prior to the addition of the items. While submerged in the liquid, the items may be agitated or further manually cleaned. System 100 may also be agitated.

Once the user determines that the items have been sufficiently exposed to the liquid, grid tray 104 is lifted from bottom work station 102, as shown in FIG. 5. During this step, substantially all of the liquid will drain from grid tray 104 through grid portion 111 and into bottom work station 102. Gentle agitation may be applied to grid tray 104 in order to shake free any remaining liquid. At this point, top work station 101 may be placed in the covering position and onto bottom work station 102, as shown in FIG. 6. This allows grid tray 104 to be placed on top plane 105 so that the items may be retrieved, after which grid tray 104 and top plane 105 may be wiped dry of any remaining liquid. Instead of being replaced on bottom work station 102, top work station 101 may stand alone on a counter or flat surface during this step of the cleaning process. Top work station 101 may also be placed adjacent to and in a similar orientation to that of bottom work station 102 so that grid tray 104 may be transferred from one work station to the other. Of course, if system 200 is used, it is preferable for top work station 201 to be replaced onto bottom work station 202 during this step so grid tray 204 can rest on upper edge 216 and any excess liquid can drain back into bottom work station 202.

After some or all of the items are removed from grid tray 104, system 100 can be cleaned and stored, or grid tray 104 may be placed back inside bottom work station 102 whether or not the liquid is still present. If the liquid is still present, the cleaning process may be repeated by adding additional items to grid tray 104. This conserves and reuses the liquid. If the liquid has been removed, the method of cleaning can be repeated as described above or system 100 may be stored for future use.

A system of the present invention may be a component of a kit, which may further include one or more cleaning brushes and one or more pairs of protective gloves. The cleaning brushes may be used to assist in the cleaning process, and the gloves may be used to protect the user from exposure to dirt, grease, etc., the items themselves, and/or the liquid used for cleaning. The gloves may be disposable or reusable. One embodiment of such a kit includes a system 100, three cleaning brushes, and five pairs of gloves. When top work station 101 is in its nesting position, any cleaning brushes or gloves included with system 100 may be disposed within top work station 101 adjacent to top inner surface 118.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A cleaning system for cleaning items at least partially submerged within a liquid comprising:
a bottom work station having a bottom outer surface and a bottom inner surface and configured to contain the liquid;
a top work station having a top outer surface and a top inner surface, the top work station having a nesting position so as to be nestingly received within the bottom work station wherein the top outer surface faces the bottom inner surface, and a covering position wherein the top inner surface faces the bottom inner surface; and
a grid tray having a grid portion, the grid tray configured to be inserted into the bottom work station and to contain items to be at least partially submerged and cleaned in the liquid, the grid tray further configured to be received and retained on the top outer surface when the top work station is in the covering position to allow for drying of the items while the grid tray is positioned on the top work station.

2. The cleaning system of claim 1 wherein the liquid is a cleaning solution.

3. The cleaning system of claim 1 wherein the liquid is a degreasing solution.

4. The cleaning system of claim 1 wherein when the top work station is in the covering position, the top work station and the bottom work station interconnect to form a closed container.

5. The cleaning system of claim 1 wherein the grid tray is configured to be inserted into the top work station.

6. The cleaning system of claim 1 further comprising at least one clip configured to secure the top work station to the bottom work station.

7. The cleaning system of claim 6 wherein the at least one clip is attached to the top work station.

8. The cleaning system of claim 1 wherein the top work station includes a top plane and a lip disposed on the top outer surface and circumferentially about the top plane.

9. The cleaning system of claim 8 wherein the top plane and the grid portion are substantially similarly dimensioned, and wherein the lip removably secures the grid tray to the top work station.

10. The cleaning system of claim 1 wherein the top work station includes a top rim and a gasket disposed at least partially within the top rim.

11. The cleaning system of claim 1 wherein the bottom work station includes a bottom rim and a gasket disposed at least partially within the bottom rim.

12. The cleaning system of claim 1 wherein the grid portion is perforated.

13. The cleaning system of claim 1 wherein the top work station includes a plurality of walls that define an opening.

14. The cleaning system of claim 1, further comprising at least one of a cleaning brush and a pair of gloves.

15. The cleaning system of claim 14 wherein the at least one cleaning brush and pair of gloves are disposed within the top work station when the top work station is in the nesting position.

16. A method of cleaning items comprising:
providing a cleaning system including a top work station, a bottom work station, and a grid tray having a grid portion, the bottom work station having a bottom outer surface and a bottom inner surface, the top work station having a top outer surface, a top inner surface, a nesting position wherein the top outer surface faces the bottom inner surface, and a covering position wherein the top inner surface faces the bottom inner surface;
placing the grid tray into the bottom work station;
placing items to be cleaned into the grid tray;
pouring the liquid into the bottom work station so as to at least partially submerge the items;
removing the grid tray containing the items from the bottom work station;
placing the top work station in the covering position and onto the bottom work station; and
placing the grid tray containing the items onto the top outer surface.

17. The method of claim 16 wherein the liquid is a cleaning solution.

18. The method of claim 16 wherein the liquid is a degreasing solution.

19. A cleaning system for cleaning items at least partially submerged within a liquid comprising:
a bottom work station having a tray-like configuration with a bottom outer surface and a bottom inner surface, the bottom work station further including a bottom plane and four bottom walls extending therefrom, each bottom wall being connected to exactly two other bottom walls, wherein each bottom wall forms an obtuse angle with the bottom plane, wherein the bottom work station is configured to contain the liquid;
a top work station having a tray-like configuration with a top outer surface and a top inner surface, the top work station further including a top plane and four top walls extending therefrom, each top wall being connected to exactly two other top walls, wherein each top wall forms an obtuse angle with the top plane, wherein the top work station is configured to be arranged in a nesting position wherein the top outer surface faces the bottom inner surface and in a covering position wherein the top inner surface faces the bottom inner surface; and
a grid tray having a grid portion, the grid tray configured to be inserted into the bottom work station and to contain items to be at least partially submerged and cleaned in the liquid, the grid tray having a tray-like configuration with a grid tray outer surface and a grid tray inner surface, the grid tray further including four grid tray walls extending from the grid portion, each grid tray wall being connected to exactly two other grid tray walls, wherein each grid tray wall forms an obtuse angle with the grid portion, the grid tray further configured to be received and retained on the top outer surface when the top work station is in the covering position while the grid tray contains the items to allow for drying of the items while the grid tray is positioned on the top work station;
wherein the system is configured to be arranged in a storage position wherein the top work station is disposed in the nesting position in the bottom work station, and the grid tray disposed therebetween;
wherein the system is configured to be arranged in a cleaning position wherein the top work station is disposed in the covering position on the bottom work station, and the grid tray disposed within the bottom work station; and
wherein the system is configured to be arranged in a drying position wherein the top work station is disposed in the covering position on the bottom work station, and the grid tray is retainingly disposed on the top outer surface of the top work station.

20. The cleaning system of claim 19 wherein the liquid is a degreasing solution.
